(19) United States
(12) Patent Application Publication
(10) Pub. No.: US 2020/0209662 A1
(43) Pub. Date: Jul. 2, 2020

(54) PIXEL STRUCTURE

(71) Applicant: Au Optronics Corporation, Hsinchu (TW)

(72) Inventors: Min-Hsuan Chiu, Taipei City (TW); Ju-Chin Chen, Taipei City (TW); Wei-Ming Cheng, Taipei City (TW); Seok-Lyul Lee, Hsinchu City (TW)

(73) Assignee: Au Optronics Corporation, Hsinchu (TW)

(21) Appl. No.: 16/516,280

(22) Filed: Jul. 19, 2019

(30) Foreign Application Priority Data
Dec. 28, 2018 (TW) 107147563

(51) Int. Cl. G02F 1/1365; G02F 1/1362

(52) U.S. Cl. CPC G02F 1/1365; G02F 1/136227; G02F 1/136209

(57) ABSTRACT

A pixel structure includes a substrate, a first metal layer, a first insulating layer, a conductive layer, a second insulating layer, and a second metal layer. The first metal layer is located on a substrate. The first metal layer includes a data line and a source connected to the data line. The first insulating layer covers the first metal layer. The conductive layer is located on the first insulating layer. The conductive layer includes a semiconductor channel and a first electrode. The semiconductor channel is electrically connected to the source. At least one portion of the first electrode is located in an opening area of the pixel structure. The second insulating layer covers the conductive layer. The second metal layer is located on the second insulating layer. The second metal layer includes a scan line and a gate connected to the scan line. The gate overlaps the semiconductor channel.

### CROSS-REFERENCE TO RELATED APPLICATION

This application claims the priority benefit of Taiwan application serial no. 107147563, filed on Dec. 28, 2018. The entirety of the above-mentioned patent application is hereby incorporated by reference herein and made a part of this specification.

### TECHNICAL FIELD

The disclosure relates to a pixel structure; more particularly, the disclosure relates to a pixel structure of which a data line is formed before a semiconductor channel is formed.

### DESCRIPTION OF RELATED ART

A liquid crystal display (LCD) is one of the most mature and widely used display apparatuses among various flat panel display apparatuses. Generally, the LCD includes a plurality of pixel structures of which electrodes are applied to control the liquid crystal molecules to change orientation. Through the orientation of the liquid crystal molecules, whether beams emitted by a backlight module can pass through a liquid crystal layer can be controlled. Among the existing LCDs, the pixel structures include a plurality of patterned film layers; for instance, after an active device in the pixel structure is formed, additional manufacturing steps are often required to form a pixel electrode and a common electrode, which increases the difficulty in the process of manufacturing the pixel structures. Hence, many manufacturers are devoted to simplification of the manufacturing process of the pixel structure, so as to lower down the manufacturing costs of the LCDs.

### SUMMARY

The disclosure provides a pixel structure made by a simple manufacturing process at low manufacturing costs.

In an embodiment of the disclosure, a pixel structure including a substrate, a first metal layer, a first insulating layer, a conductive layer, a second insulating layer, and a second metal layer is provided. The first metal layer is located on a substrate. The first metal layer includes a data line and a source connected to the data line. The first insulating layer covers the first metal layer. The conductive layer is located on the first insulating layer. The conductive layer includes a semiconductor channel and a first electrode. The semiconductor channel is electrically connected to the source. At least one portion of the first electrode is located in an aperture region of the pixel structure. The second insulating layer covers the conductive layer. The second metal layer is located on the second insulating layer. The second metal layer includes a scan line and a gate connected to the scan line. The gate overlaps the semiconductor channel.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1A is a schematic top view of a pixel structure according to an embodiment of the disclosure.

FIG. 1B is a schematic cross-sectional view taken along a sectional line aa′ in FIG. 1A.

FIG. 1C is a schematic cross-sectional view taken along a sectional line bb′ in FIG. 1A.

FIG. 2A is a schematic top view of a pixel structure according to an embodiment of the disclosure.

FIG. 2B is a schematic cross-sectional view taken along a sectional line cc′ in FIG. 2A.

FIG. 2C is a schematic cross-sectional view taken along a sectional line dd′ in FIG. 2A.

### DESCRIPTION OF THE EMBODIMENTS

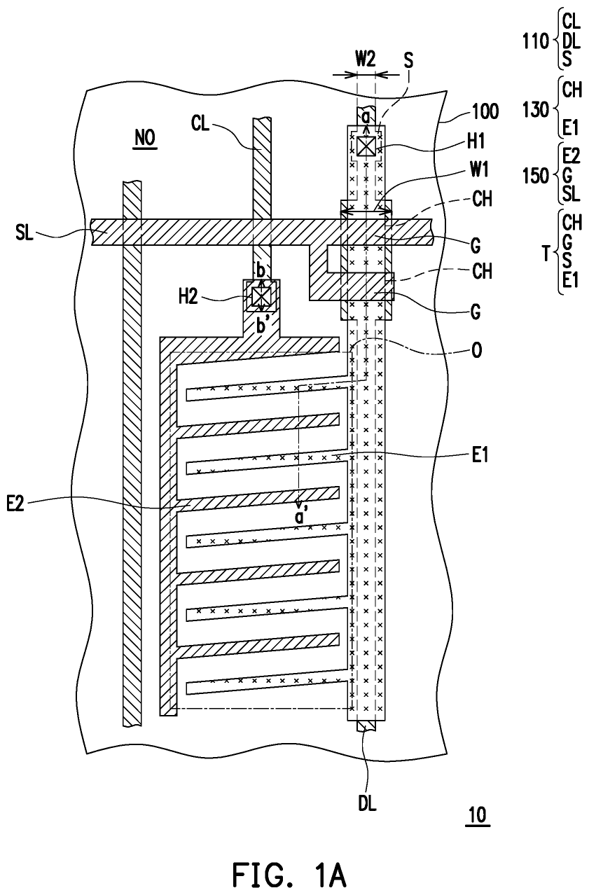

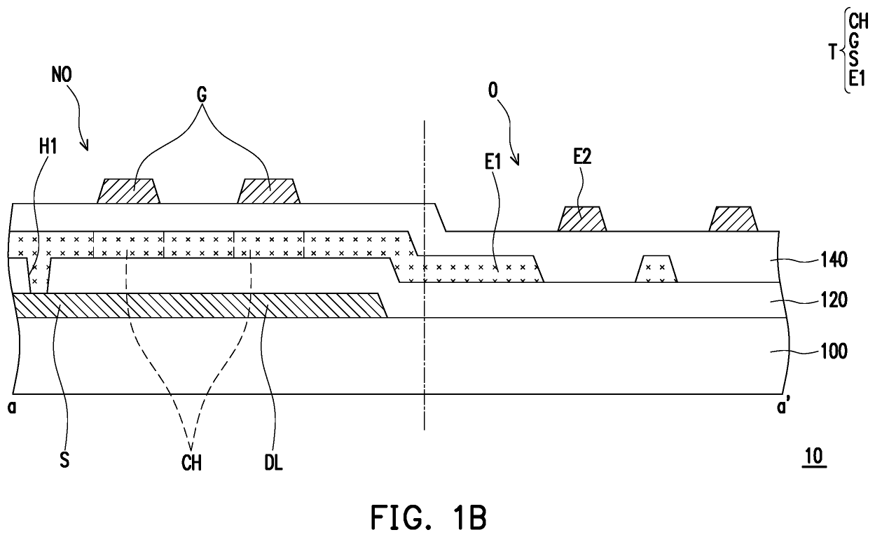

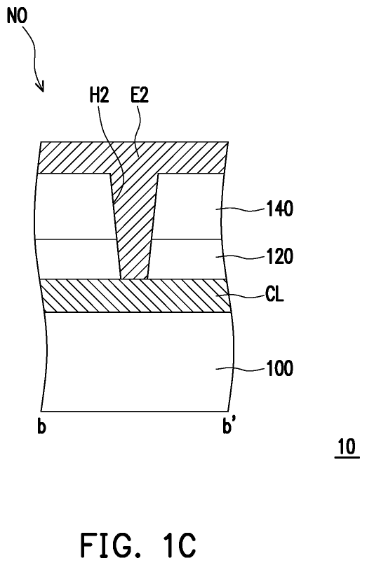

FIG. 1A is a schematic top view of a pixel structure according to an embodiment of the disclosure. FIG. 1B is a schematic cross-sectional view taken along a sectional line aa′ in FIG. 1A. FIG. 1C is a schematic cross-sectional view taken along a sectional line bb′ in FIG. 1A.

With reference to FIG. 1A to FIG. 1C, a pixel structure 10 includes a substrate 100, a first metal layer 110, a first insulating layer 120, a conductive layer 130, a second insulating layer 140, and a second metal layer 150. In the present embodiment, the pixel structure 10 includes an aperture region O and a non-aperture region NO at peripheries of the aperture region O. According to some embodiments, a black matrix (not shown) overlaps the non-aperture region NO and has a through hole corresponding to the aperture region O.

The first metal layer 110 is located on the substrate 100. The first metal layer 110 includes a data line DL and a source S connected to the data line DL. In the present embodiment, the first metal layer 110 further includes a signal line CL.

The first insulating layer 120 covers the first metal layer 110. In the present embodiment, the first insulating layer 120 further covers the substrate 100. The conductive layer 130 is located on the first insulating layer 120. The conductive layer 130 includes a semiconductor channel CH and a first electrode E1.

The semiconductor channel CH is electrically connected to the source S. In the present embodiment, the conductive layer 130 is electrically connected to the source S through the opening H1, which should however not be construed as a limitation in the disclosure. The opening H1 penetrates the first insulating layer 120, for instance. At least one portion of the first electrode E1 is located in the aperture region O of the pixel structure 10. The first electrode E1 partially overlaps the data line DL.

In the present embodiment, conductivity of the first electrode E1 is greater than conductivity of the semiconductor channel CH. For instance, the conductive layer 130 includes amorphous silicon, polycrystalline silicon, microcrystalline silicon, monocrystalline silicon, an oxide semiconductor material (e.g., indium zinc oxide, indium gallium zinc oxide, any other appropriate material, or a combination thereof), any other appropriate material, or a combination thereof. Through a doping process, a doping concentration of dopants in the conductive layer 130 can be adjusted to control the conductivity of different regions of the conductive layer 130, and the conductivity of the first electrode E1 is designed to be greater than the conductivity of the semiconductor channel CH.

In the present embodiment, one portion of the data line DL overlaps the semiconductor channel CH. The data line DL acting as a light shielding layer can better resolve the current leakage issue of the semiconductor channel CH. The one portion of the data line DL overlapping the semiconductor channel CH has a first line width W1, the other portion of the data line DL not overlapping the semiconductor channel CH has a second line width W2, and the first line width W1 is greater than the second line width W2.

The second insulating layer 140 covers the conductive layer 130. In the present embodiment, the second insulating layer 140 further covers the first insulating layer 120. The second metal layer 150 is located on the second insulating layer 140. The second metal layer 150 includes a scan line SL and a gate G connected to the scan line SL. In the present embodiment, the second metal layer 150 further includes a second electrode E2. The second electrode E2 is at least partially located in the aperture region O of the pixel structure 10.

The gate G overlaps the semiconductor channel CH. In the present embodiment, a doping process is performed on the conductive layer 130 after the second metal layer 150 is formed. For instance, the second metal layer 150 is applied as a mask to perform the doping process on the conductive layer 130, so as to adjust the conductivity of the conductive layer 130. The semiconductor channel CH covered by the second metal layer 150 has a doping concentration lower than the doping concentration of the first electrode E1 not covered by the second metal layer 150. According to other embodiments, it is likely to additionally form other mask layers on the conductive layer 130 before the second metal layer 150 is formed, and another mask layer can be applied to serve as the mask required for performing the doping process.

In the present embodiment, the pixel structure 10 includes a switch device T that includes a gate G, a semiconductor channel CH, and a source S. The first electrode E1 is electrically connected to the semiconductor channel CH; that is, the first electrode E1 is the drain of the switch device T. In the present embodiment, the switch device T is a dual-gate switch device, whereby the current leakage issue of the switch device T can be better resolved; however, the disclosure is not limited thereto. The number of gates of the switch device T can be adjusted according to actual demands.

In the present embodiment, the second electrode E2 is electrically connected to the signal line CL through the opening H2, which should however not be construed as a limitation in the disclosure. The opening H2 penetrates the first insulating layer 120 and the second insulating layer 140, for instance. In the present embodiment, the second electrode E2 can serve as a common electrode, and the first electrode E1 can serve as a pixel electrode. An electric field between the first electrode E1 and the second electrode E2 can be applied to control a rotation direction of liquid crystal molecules.

In the present embodiment, the first electrode E1 and the second electrode E2 are both shaped as a comb, for instance, which should however not be construed as a limitation in the disclosure. According to other embodiments, the first electrode E1 and the second electrode E2 may be of another shape.

In an embodiment of the disclosure, a material of the second electrode E2 includes metal. Since metal is capable of blocking the dark zone above the electrodes, the pixel structure 10 provided in the present embodiment is able to improve the contrast ratio of an LCD device.

In view of the above, the first metal layer 110 is formed before the conductive layer 130 is formed, the first electrode E1 of the conductive layer 130 acts as the pixel electrode, and the second electrode E2 of the second metal layer 150 acts as the common electrode, so as to simplify the manufacturing process of the pixel structure 10, reduce the number of photomasks required for performing said manufacturing process, and thereby save manufacturing costs.

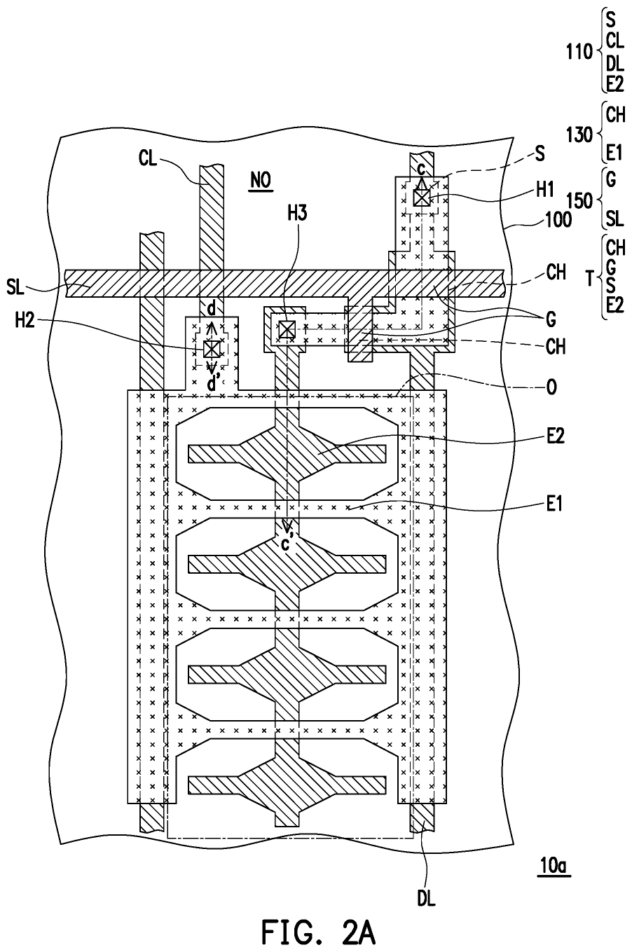

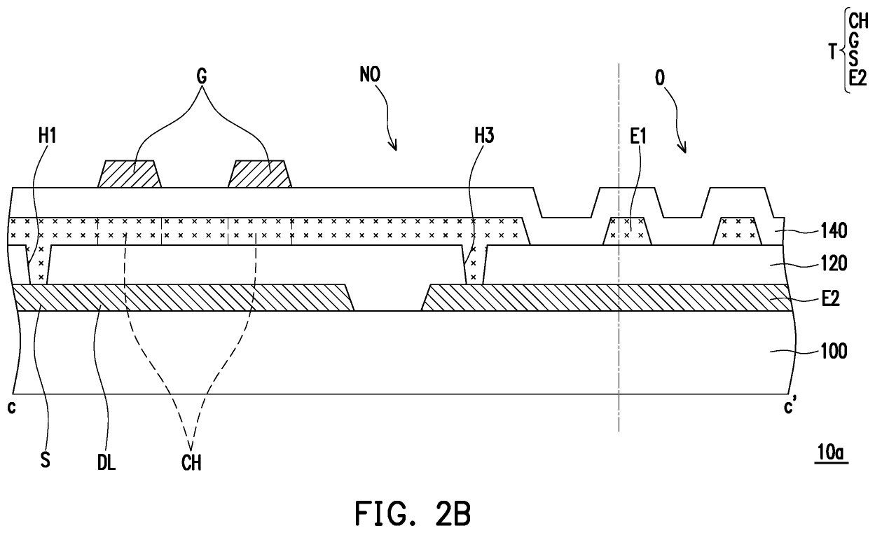

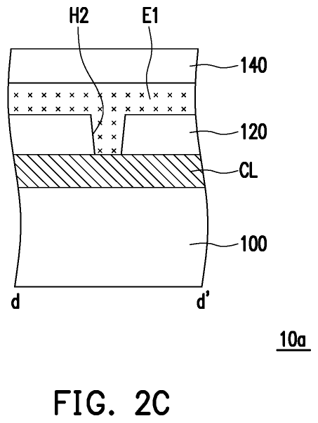

FIG. 2A is a schematic top view of a pixel structure according to an embodiment of the disclosure. FIG. 2B is a schematic cross-sectional view taken along a sectional line cc′ in FIG. 2A. FIG. 2C is a schematic cross-sectional view taken along a sectional line dd′ in FIG. 2A. It should be noted that the reference numbers and a part of the contents in the previous embodiment depicted in FIG. 1A to FIG. 1C are used in the following embodiments depicted in FIG. 2A to FIG. 2C, in which identical reference numbers indicate identical or similar components, and repeated description of the same technical contents is omitted. For a detailed description of the omitted parts, reference can be found in the previous embodiment, and no repeated description is contained in the following embodiments.

The difference between a pixel structure 10a depicted in FIG. 2A to FIG. 2C and the pixel structure 10 depicted in FIG. 1A to FIG. 1C lies in that the first metal layer 110 of the pixel structure 10a includes a second electrode E2.

With reference to FIG. 2A to FIG. 2C, the first metal layer 110 is located on the substrate 100. The first metal layer 110 includes the data line DL and the source S connected to the data line DL. In the present embodiment, the first metal layer 110 further includes a signal line CL and a second electrode E2. The second electrode E2 is at least partially located in the aperture region O of the pixel structure 10a.

The first insulating layer 120 covers the first metal layer 110. In the present embodiment, the first insulating layer 120 further covers the substrate 100. The conductive layer 130 is located on the first insulating layer 120. The conductive layer 130 includes a semiconductor channel CH and a first electrode E1.

The first insulating layer 120 covers the first metal layer 110. In the present embodiment, the first insulating layer 120 further covers the substrate 100. The conductive layer 130 is located on the first insulating layer 120. The conductive layer 130 includes a semiconductor channel CH and a first electrode E1.

The semiconductor channel CH is electrically connected to the source S. In the present embodiment, the conductive layer 130 is electrically connected to the source S through the opening H1, which should however not be construed as a limitation in the disclosure. The semiconductor channel CH is electrically connected to the second electrode E2. In the present embodiment, the conductive layer 130 is electrically connected to the second electrode E2 through an opening H3, which should however not be construed as a limitation in the disclosure. The opening H1 and the opening H3 penetrate the first insulating layer 120, for instance.

The second insulating layer 140 covers the conductive layer 130. In the present embodiment, the second insulating layer 140 further covers the first insulating layer 120. The second metal layer 150 is located on the second insulating layer 140. The second metal layer 150 includes a scan line SL and a gate G connected to the scan line SL.

The gate G overlaps the semiconductor channel CH. In the present embodiment, a doping process is performed on the conductive layer 130 after the second metal layer 150 is formed. For instance, the second metal layer 150 is applied as a mask to perform the doping process on the conductive layer 130, so as to adjust the conductivity of the conductive layer 130. The semiconductor channel CH covered by the second metal layer 150 has a doping concentration lower than the doping concentration of the first electrode E1 not covered by the second metal layer 150. According to other embodiments, it is likely to additionally form other mask layers on the conductive layer 130 before the second metal layer 150 is formed, and another mask layer can be applied to serve as the mask required for performing the doping process.

In the present embodiment, the switch device T includes the gate G, the semiconductor channel CH, and the source S. The second electrode E2 is electrically connected to the semiconductor channel CH; that is, the second electrode E2 is the drain of the switch device T.

At least one portion of the first electrode E1 is located in an aperture region O of the pixel structure 10a. In the present embodiment, the first electrode E1 is electrically connected to the signal line CL through the opening H2, which should however not be construed as a limitation in the disclosure. The opening H2 penetrates the first insulating layer 120, for instance. In the present embodiment, the first electrode E1 can serve as the common electrode, and the second electrode E2 can serve as the pixel electrode. An electric field between the first electrode E1 and the second electrode E2 can be applied to control a rotation direction of liquid crystal molecules.

In the present embodiment, the first electrode EL electrically connected to the signal line CL partially overlaps the data line DL. The first electrode E1 can prevent the data line DL from posing any impact on the electric field in the aperture region O.

In the present embodiment, the first electrode E1 and the second electrode E2 together constitute a honeycomb electrode. In the present embodiment, the design of the shape of the first electrode E1 and the shape of the second electrode E2 contributes to the reduced actuating region of liquid crystal molecules, whereby the reaction time of the liquid crystal molecules can be can be reduced. In an embodiment of the disclosure, a material of the second electrode E2 includes metal. Since metal is capable of blocking the dark zone above the electrodes, the pixel structure 10a provided in the present embodiment is able to improve the contrast ratio of an LCD device.

To sum up, the first metal layer 110 is formed before the conductive layer 130 is formed, the first electrode E1 of the conductive layer 130 acts as the common electrode, and the second electrode E2 of the second metal layer 150 acts as the pixel electrode, so as to simplify the manufacturing process of the pixel structure 10a, reduce the number of photomasks required for performing said patterning process, and thereby save manufacturing costs.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A pixel structure comprising:
a substrate;
a first metal layer located on the substrate and comprising a data line and a source connected to the data line;
a first insulating layer covering the first metal layer;
a conductive layer located on the first insulating layer and comprising a semiconductor channel and a first electrode, wherein the semiconductor channel is electrically connected to the source, and at least one portion of the first electrode is located in an aperture region of the pixel structure;
a second insulating layer covering the conductive layer; and
a second metal layer located on the second insulating layer and comprising a scan line and a gate connected to the scan line, wherein the gate overlaps the semiconductor channel.

2. The pixel structure according to claim 1, wherein the second metal layer further comprises a second electrode, and at least one portion of the second electrode is located in the aperture region of the pixel structure.

3. The pixel structure according to claim 2, wherein the first electrode is electrically connected to the semiconductor channel.

4. The pixel structure according to claim 2, wherein the first metal layer further comprises a signal line, and the second electrode is electrically connected to the signal line.

5. The pixel structure according to claim 1, wherein the first metal layer further comprises a signal line, and the first electrode is electrically connected to the signal line.

6. The pixel structure according to claim 1, wherein the first metal layer further comprises a second electrode, and the semiconductor channel is electrically connected to the second electrode.

7. The pixel structure according to claim 1, wherein one portion of the first electrode overlaps the data line.

8. The pixel structure according to claim 1, wherein one portion of the data line overlaps the semiconductor channel.

9. The pixel structure according to claim 8, wherein the one portion of the data line overlapping the semiconductor channel has a first line width, the other portion of the data line not overlapping the semiconductor channel has a second line width, and the first line width is greater than the second line width.

10. The pixel structure according to claim 1, wherein conductivity of the first electrode is greater than conductivity of the semiconductor channel.
